(19) United States
(12) Patent Application Publication
(10) Pub. No.: US 2006/0294004 A1
(43) Pub. Date: Dec. 28, 2006

(54) On-line currency exchange rate update for mobile phones

(76) Inventor: Stuart Burge, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,842

(22) PCT Filed: Sep. 1, 2004
(86) PCT No.: PCT/IB04/51663

§ 371 Date: Mar. 6, 2006

Related U.S. Application Data
(60) Provisional application No. 60/500,074, filed on Sep. 4, 2003.

(51) Int. Cl. G06Q 40/00

(52) U.S. Cl. 705/39; 705/64; 235/380

(57) ABSTRACT

A system and method enables a mobile service provider to store and provide a selection of currency exchange rates directly for use in a user's mobile phone. This means that daily exchange rate calculations are accurate and daily updates ensured. The mobile phone user only needs to select the ‘to’ and ‘from’ exchange rate currencies that he/she wishes to use. The system and method enables downloading to the mobile phone of the specified exchange rate currencies directly from the mobile phone service provider, and further obviates the need for a separate application to be downloaded to provide this function.

Many mobile phone devices, mobile phone subscriber plans and phone service providers existing today are equipped with and provide functionality for converting from one currency exchange rate to another. This is extremely useful for the traveler who uses his/her mobile phone abroad. Typically, a user of the mobile phone may type in the exchange rate for the currency he/she wishes to convert.

For example, the Sony Ericsson P800 GSM/EGSM Cellular Phone is a ‘smart’ mobile phone equipped with internet-type connectivity including a WorldMate travel utility including a currency-converter application for smart phones. Before the exchange rate data can be retrieved, however, the smart phone must first be connected to an Internet site which provides the required exchange rates, i.e., the exchange rates come from a source outside of the mobile service provider. This means that the user must start the WorldMate application and then select the required exchange rate which are then downloaded. After that, the currency conversion is performed by navigating the mobile phone menu to the correct option. One disadvantage however, is that currency exchange rates change daily and the user must know the correct currency exchange rate in advance.

Likewise, Wireless Access Protocol-enabled (WAP-enabled) phones such as the Nokia 7110 inherently involves steps such as initiating the WAP application, connecting to the WAP-service provider and then navigating to the URL given. This requires a connection to a WAP service provider and means for navigating menus and paying call costs when all the user wants is to know a simple exchange rate at the touch of a button. If the user is overseas then the costs may be considerable.

It would be advantageous to enable the mobile service provider to provide the exchange rates to the phone. While the exchange rates may be retrieved from the Internet by the mobile phone service provider, this is of no concern to the user: the service provider functions as the information portal.

It would further be advantageous to enable exchange rate currency data retrieval conversion without requiring initiation of a separate application that is not already built into the phone's software itself, e.g., a downloaded application.

According to the present invention, there is provided a system and method enabling mobile service provider to transmit user requested currency exchange rates directly for use in a user's mobile phone. This means that daily currency exchange rate calculations are accurate and may be updated. Preferably, the user phone ‘pulls’ the exchange rates from the service provider when the phone's software determines it is necessary. The mobile phone user only needs to select the ‘to’ and ‘from’ exchange that he/she wishes to use.

As the currency exchange rates may change daily, the rates have an associated expiration period, e.g., a day. After the expiry period when the software determines the exchange rate is no longer valid, e.g., the day after the exchange rate was last retrieved, then when a new exchange rate calculation is initiated by the user of the mobile phone, the phone's software will initiate a currency exchange rate request to the service provider. From the user's point of view the update is ‘automatic’ because the request is done transparently. There may be a small time pause between the exchange rate request initiated by the mobile phone user and the exchange rate calculation but the user will not be made aware from the phone's user interface or otherwise that a request was necessary to obtain the exchange rate.

Preferably, the invention may be used in a mobile phone by making use of the existing protocol for data transmission. In an exemplary embodiment, a GSM mobile phone may generate one or more request codes to retrieve the required data. However, this method may be similar to the way a “remaining credit” balance can be requested and displayed on screen for pre-paid type mobile phones.

The objects, features and advantages of the present invention will become apparent to one skilled in the art, in view of the following detailed description taken in combination with the attached drawing, in which:

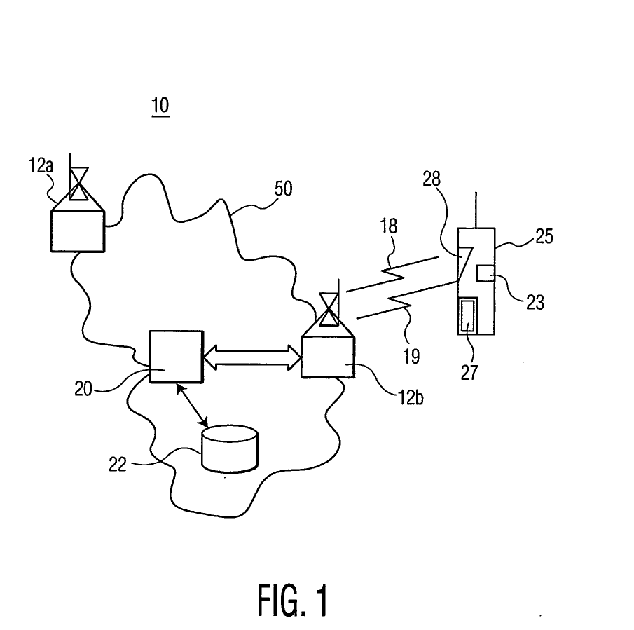

FIG. 1 depicts a generic block diagram 10 of the system for transmitting a selection of currency exchange rates directly for use in a user's mobile phone.

As depicted in FIG. 1, there is shown the major comments of a mobile phone system including, but not limited to: a networked collection 50 of radio towers 12a, 12b in a geographic area, linked together, for wirelessly transmitting people's conversations and other data via a mobile phone communications standard, such as time or code division multiplex access schemes (TDMA, CDMA), e.g., GSM, 3G, etc. A mobile/cell phone service provider, depicted as element 20 typically sells a mobile phone 25 or handset to the customer, and also arranges connection to the network 50, as well as a customer billing account. Built-in to the mobile phone's operating software is the functionality for requesting and receiving currency exchange rate downloads directly form a mobile-phone service provider 20. Particularly, the software includes functionality, including a phone display interface 28, for setting an exchange rate. This functionality involves manually entering the exchange currencies via the mobile phone's keypad 27: an entry of a foreign currency unit, for example, in terms of a domestic currency unit (e.g., Euro and Dollar), or vice versa, an entry for expressing a domestic unit in foreign units. As shown in FIG. 1, the software generates request code messages 18 identifying the mobile phone customer and the requesting the exchange rate expressions, for example, by making use of the existing communications protocol for data transmission. According to the invention, the service provider receives these coded transmissions 18 and as will be explained in greater detail herein, downloads directly to the mobile phone the requested exchange rate(s) via coded messages 19. Once these values have been received, then the regular mobile phone operating software may be initiated for making a telephone call. To this end, a user may simply type a number on the phone keypad 28, and the user will then be presented with an option to convert the number into foreign and domestic units in a manner as facile as dialing the call number.

In the preferred embodiment, this currency exchange rate functionality does not require a separate application to be downloaded. The exchange rate functionality in the mobile phone can be further extended to select the domestic and foreign currencies, e.g., euro and dollars. Particularly, to set up the mobile phone to convert one currency to another, the following steps are performed: Assuming the phone is turned on, the user selects a “currency exchange” menu via interface 28 which provides a series of menu choices such as: ‘set domestic currency’ menu choice or ‘set foreign currency’ menu choice. For example, from the ‘set domestic currency’ menu choice, a user may select ‘Euro’ from list of available currencies (or using phone keypad type EUR indicating the currency wanted is Euro); afterwards, from the ‘set foreign currency’ menu choice, a user may select ‘US Dollar’ from the list of available currencies (or using phone keypad type USD indicating the currency wanted is US Dollar).

Preferably, the requested currency exchange rate information is included as part of the subscription service or, may be provided as a surcharge service by the mobile phone provider. There is no need for the user to manually enter any data related to exchange rates, e.g., $1=EUR 1.10.

According to this scheme, the first time a user wishes to convert a currency, the user types the amount into the phone keypad and, as shown in FIG. 1, selects a keypad button 23 initiating unit conversion. Assuming the phone is turned on, the user types the number into phone keypad (as if going to make a call), e.g., 123.45. The user then selects a keypad button 23 to instruct the phone that the entered number should be currency exchanged (and not called). The mobile phone then checks internal memory for the current day's Euro-to-Dollar and Dollar-to-Euro exchange rates. If the, phone's internal memory is empty or contains old exchange rates (e.g., yesterday's rates) then a request to the service provider is opened and a coded request for the Euro-to-Dollar and Dollar-to-Euro rates exchange rates is communicated to the service provider, after which time the requested rates are downloaded from the service provider over the communications channel set up for the exchange. If the rates are received, then these two values they may be stored in the phone's domestic-to-foreign and foreign-to-domestic memory (under EUR⇄USD rates). Additionally stored are the date and time of when these exchange values were retrieved. If the rates are not received then display error to user indicating rates unavailable.

Functionality is additionally provided to inform a user to manually input the domestic-to-foreign and foreign-to-domestic rates. Afterwards, once the current exchange rates are provided, the currency exchange of entered number 123.45 in domestic and foreign units is performed in the phone and the values are displayed on the phone interface screen.

If desired, a user may press the button 23 again, e.g., press the button to clear the display, and perform a currency exchange operation again if necessary. In this case, the user may select another currency by entering the number into phone keypad as described.

The phone knows that it does not have today's current exchange rate stored in its memory. It therefore sends a code to the mobile phone provider requesting the Euro-Dollar and Dollar-Euro rates. In a preferred embodiment, referring to FIG. 1, the mobile service provider 20 stores a daily updated selection of currency exchange rates that can be selected via the phone device in a database 22. When the mobile user first requests a currency exchange rate then the mobile phone sends out request messages 18 querying the mobile service provider for that particular exchange rate. The exchange rate is downloaded by the service provider to the mobile phone together with a time stamp which data are stored in the phone. After a few seconds, the phone receives the domestic to foreign and foreign to domestic rates and stores these rates in a memory storage provided in the phone which remain valid for the rest of the day, for example. It is understood that a user can change the currency countries as many times as he/she wants in one day. When a currency calculation is executed, the phone's software will check if it has or doesn't have that current day's exchange rates for that particular currency stored in its memory. If it doesn't have the updated exchange rates, then it will request the domestic-to-foreign and foreign-to-domestic rates from the service provider via request message 18. No more requests to the service provider need to be initiated until the exchange rate is deemed no longer valid (e.g., after one day) regardless of the number of exchange rate calculations performed on the phone. The currency exchange calculation is performed in the phone regardless of whether the currency exchange rate is requested from the service provider.

Further, the exchange rate request only needs to be performed when the phone doesn't have a up-to-date domestic-to-foreign and foreign-to-domestic stored in its memory. There is no requirement for every calculation to set-up an exchange rate request to the service provider. This would generate a lot of unnecessary data traffic. The phone already has a built-in calculator so the simple division or multiplication is performed in the phone.

When added to a mobile phone standard like the Global System for Mobile Communications (GSM), the look-up of the exchange rate data is transparent and does not require a WAP-enabled phone nor any access to services beyond which the mobile service provider gives. When the codes are standardized in the mobile phone standard then a user can move between countries which offer the same standard and still retrieve the exchange rate completely transparently.

This method is similar to the way the remaining credit balance can be requested and displayed on screen for pre-paid type mobile phones.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. An on-line currency exchange system for mobile phones comprising:
means implemented in said mobile phone for setting a currency exchange rate in said mobile phone, said means enabling entry of exchange rate currencies such that a mobile phone call to be made according to first currency units may be converted in terms of second currency units;
means for requesting receipt of a current said exchange rate from a mobile phone service provider according to the entered values;
means for providing a current currency exchange rate and communicating said rate to said mobile phone in response to said request,
wherein, a dialed number initiated from said mobile phone may be converted from said first units into said second currency units in said mobile phone.

2. The on-line currency exchange system as claimed in claim 1, further comprising means for establishing an update period setting forth validity of said stored currency exchange rate, said means associating a time stamp with a stored currency exchange rate.

3. The on-line currency exchange system as claimed in claim 2, wherein said time stamp is communicated with said requested currency exchange rate and stored in said mobile phone.

4. The on-line currency exchange system as claimed in claim 2, further comprising means for updating a requested currency exchange rate for said mobile phone if after an update period, said means comparing said timestamp with a current time and sending new exchange rate to said mobile phone if after said update period.

5. The on-line currency exchange system as claimed in claim 1, further comprising means for modifying said update period.

6. The on-line currency exchange system as claimed in claim 1, wherein said mobile phone service provider stores selections of updated currency exchange rates.

7. The on-line currency exchange system as claimed in claim 1, further including keypad means enabling entry of a calling number into said mobile phone.

8. A method for providing currency exchange information to mobile phones comprising the steps of:
a) setting a currency exchange rate in said mobile phone by enabling entry of exchange rate currencies such that a mobile phone call to be made according to first currency units may be converted in terms of second currency units;
b) requesting receipt of a current said exchange rate from mobile phone service provider;
c) communicating said current currency exchange rate to said mobile phone in response to said request, and,
d) converting a subsequent call made via said phone into said second currency units.

9. The method as claimed in claim 8, further comprising the steps of:
establishing an update period setting forth validity of said stored currency exchange rate; and,
associating a time stamp with a stored currency exchange rate.

10. The method as claimed in claim 9, further including:
communicating said time stamp with said requested currency exchange rate for storage in said mobile phone.

11. The method as claimed in claim 9, further comprising the step of: updating a requested currency exchange rate for said mobile phone if after an update period, said means comparing said timestamp with a current time and sending a new exchange rate to said mobile phone if after said update period.

12. The method as claimed in claim 9, further comprising the step of enabling modification of said update period.
